(19) United States
(12) Patent Application Publication
(10) Pub. No.: US 2014/0008910 A1
(43) Pub. Date: Jan. 9, 2014

(54) ADJUSTABLE PIPE CONNECTOR

(71) Applicant: Arie PRIZANT, Ramat Yishay (IL)

(72) Inventor: Arie PRIZANT, Ramat Yishay (IL)

(21) Appl. No.: 13/568,978

(22) Filed: Aug. 7, 2012

Related U.S. Application Data
(63) Continuation of application No. 13/544,367, filed on Jul. 9, 2012.

(51) Int. Cl. F16L 27/02; B23P 11/00

(52) U.S. Cl. 285/147.1; 29/525.02

(57) ABSTRACT

An adjustable pipe connector device for connecting two pipes, each of the pipes having a central axis, includes at least three disks. Each of the disks has a bore extending between opposite surfaces of that disk. The disks include two opposite external disks and a central disk between the two opposite external disks. The bore of each of the opposite external disks is connectable to one of the pipes. Each of the opposite external disks is rotatable relative to the central disk so as to achieve a configuration wherein the device matchingly connects between the pipes when the central axes of the pipes are laterally offset, angularly misaligned or both, the bores of the disks forming a flow path between the pipes.

### CROSS-REFERENCE TO RELATED APPLICATIONS

This application is a continuation of U.S. patent application Ser. No. 13/544,367, filed Jul. 9, 2012, which is hereby incorporated by reference.

### FIELD OF THE INVENTION

The present invention relates to pipe connectors. More particularly, the present invention relates to a pipe connector that is adjustable to connect two pipes.

### BACKGROUND OF THE INVENTION

Incorporation of pipes in a fluid transport system for transport of a fluid, such as a liquid or gas, must often satisfy various, and sometimes conflicting, requirements, conditions, or constraints. Such constraints may be imposed by various components of the system, or by various environmental or other design considerations.

Typically, pipes are designed to be coupled or joined when the ends to be coupled are fully aligned (parallel) and coaxial. For example, in high pressure pipe in a typical desalination plant, tolerances for pipe misalignment may be less than one millimeter. In other applications, for example in connecting glass tubing or in graphite heat exchangers, the tolerances may be even tighter. In such cases, even a small stress to the equipment or tubing may cause irreparable damage. The ends to be joined are typically either in contact with one another or at a fixed distance from one another. For example, aligned pipes may be typically coupled using such techniques as adhesion, welding, or fusion, or using mechanical connectors that include threaded ends or fittings, bolts, clamps, or flanges.

In some cases it may be necessary or advantageous to connect two pipes that are misaligned. In some cases, the pipes to be connected are not coaxial. For example, the axis of one of the pipes to be coupled may be tilted or offset with respect to the axis of the other. In other cases, a distance between the ends of the pipes may be greater than expected.

Various solutions have been described or are available for accommodating some types of misalignment. Where conditions permit, a flexible connector may be used to connect pipes that are misaligned. For example, a rubber or plastic hose, or a metal expansion joint, may be connected between the pipes to be joined. However, such flexible connectors may not be suitable under all circumstances. For example, such flexible connectors may not be suitable when the pipe diameter is too small or too large, when the distance between the ends to be joined is too short or too long, or where flow conditions may damage the flexible connector (e.g. high fluid pressure, high flow rate, corrosive substance), or when a large curvature or small bending radius would be required. Since a flexible connector could represent the weakest point of a fluid transport system, incorporation of such flexible connectors may be avoided where possible.

Other solutions enable connecting pipes under some types of misalignment, but not under others. For example, various clamps may enable a limited amount of flexibility. Witte (U.S. Pat. No. 5,101,915) describes a pipe joint in the form of a cylindrical section with outside threading for connect to pipe ends, each with inside threading. The inside or outside threading at one end may be different from that at the other, and is selected at the time of manufacture of the threading. Hirshstein (U.S. Pat. No. 1,304,980) and Shire et al. (U.S. Pat. No. 3,704,034) describe pipe couplings with two sections that are rotatable relative to one another so as to vary an axial offset between the connected pipes.

Sato (U.S. Pat. No. 4,776,617) describes pipe joint that is telescoping in order to connect pipe ends at various distances from one another, and includes spherical swiveling bearings at the ends in order to accommodate various relative angles between the joint and the pipe ends. Technology to manufacture such spherical surfaces may be expensive, thus precluding common use. Use of such a pipe joint to accommodate pipe misalignment may be limited to pipe ends that are separated by a sufficient distance so as to accommodate all of the components of the joint.

It is an object of embodiments of the present invention to provide a pipe connector that is readily manufacturable and that may accommodate a wide variety of pipe misalignments.

Other aims and advantages of embodiments of the present invention will become apparent after reading the present description and reviewing the accompanying drawings.

### SUMMARY OF THE INVENTION

There is thus provided, in accordance with some embodiments of the present invention, an adjustable pipe connector device for connecting two pipes, each of the pipes having a central axis. The device includes at least three disks, each of the disks having a bore extending between opposite surfaces of that disk. The disks include two opposite external disks and a central disk between the two opposite external disks. The bore of each of the opposite external disks is connectable to one of the pipes. Each of the opposite external disks is rotatable relative to the central disk so as to achieve a configuration wherein the device matchingly connects between the pipes when the central axes of the pipes are laterally offset, angularly misaligned or both. The bores of the disks form a flow path between the pipes.

Furthermore, in accordance with some embodiments of the present invention, one of the opposite external disks includes a flat disk whose opposite surfaces are substantially parallel to one another. The opposite surfaces of the central disk are inclined with respect to one another and the other of the opposite external disks includes an inclined disk with its opposite surfaces being inclined with respect to one another.

Furthermore, in accordance with some embodiments of the present invention, an inclination angle between the opposite surfaces of the central disk is substantially equal to an inclination angle between the opposite surfaces of the inclined disk.

Furthermore, in accordance with some embodiments of the present invention, the bore of a disk of the opposite external disks is eccentrically positioned relative to that disk.

Furthermore, in accordance with some embodiments of the present invention, a disk of the opposite external disks includes a ring with an eccentrically positioned bore that is rotatable within an eccentrically positioned bore of a surrounding ring.

Furthermore, in accordance with some embodiments of the present invention, the device further includes a mechanism for fixing the configuration, the mechanism being selected from a group of mechanisms consisting of a sleeve, a flange, and a clamp.

Furthermore, in accordance with some embodiments of the present invention, the device includes a sealing ring between a disk of the opposite external disks and the central disk.

Furthermore, in accordance with some embodiments of the present invention, the device includes a pipe extension that extends from the bore of a disk of the opposite external disks.

Furthermore, in accordance with some embodiments of the present invention, a distance of a distal end of the pipe extension from the disk from which the pipe extension extends is adjustable.

There is further provided, in accordance with some embodiments of the present invention, a method for connecting two pipes. The method includes providing at least three disks, each of the disks having a bore extending between opposite surfaces of that disk. The disks include two opposite external disks and a central disk between the opposite external disks. Each of the opposite external disks is rotatable relative to the central disk, the bores of said at least three disks forming a flow path. One of the two opposite external disks includes a flat disk and the other includes an inclined disk. The opposite surfaces of the flat disk are substantially parallel to one another and the bore of the flat disk is eccentrically positioned relative to the opposite surfaces of the flat disk. The opposite surfaces of the central disk are inclined with respect to one another and the opposite surfaces of the inclined disk are inclined with respect to one another. The method further includes rotating the inclined disk relative to the central disk to accommodate an angular misalignment between the two pipes; rotating the flat disk relative to the central disk to accommodate a lateral offset between the two pipes; and attaching one of the two pipes to the bore of the flat disk and the other of the two pipes to the bore of the inclined disk.

Furthermore, in accordance with some embodiments of the present invention, the method includes selecting a thickness of one of the disks so as to accommodate a distance between the two pipes.

Furthermore, in accordance with some embodiments of the present invention, the method includes fixing a configuration of the disks.

Furthermore, in accordance with some embodiments of the present invention, the fixing of the configuration includes operation of a mechanism selected from a group of mechanisms consisting of a sleeve, a flange, and a clamp.

Furthermore, in accordance with some embodiments of the present invention, the method includes placing an inclined ring or a flat shim ring adjacent to an outward-facing surface of one of the opposite external disks so as to enable operation of a mechanism for fixing a configuration of the disks.

Furthermore, in accordance with some embodiments of the present invention, the method includes attaching a pipe extension to the bore of a disk of the opposite external disks.

Furthermore, in accordance with some embodiments of the present invention, attaching the pipe extension includes adjusting a distance between a distal end of the pipe extension and the disk.

Furthermore, in accordance with some embodiments of the present invention, adjusting the distance comprises adjusting an extent to which the pipe extension is screwed into the bore of the disk.

Furthermore, in accordance with some embodiments of the present invention, attaching the pipe to the bore of the disk includes attaching the pipe to a distal end of the pipe extension.

Furthermore, in accordance with some embodiments of the present invention, the method includes assembling a disk of one of the disks from disk components.

Furthermore, in accordance with some embodiments of the present invention, rotating the flat disk further includes rotating an inner ring of the flat disk relative to an outer ring of the flat disk.

There is further provided, in accordance with embodiments of the current invention, a kit for providing components of an adjustable pipe connector, the kit including at least a component selected from a group of components consisting of: a flat disk, a central disk, an inclined disk, a pipe extension, an inclined ring, a flat shim ring, an O-ring, a sleeve, a flange, a stud bolt, a nut, and a clamp section.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates components of an adjustable pipe connector in accordance with an embodiment of the present invention.

FIG. 2 shows an adjustable pipe connector assembled from the components illustrated in FIG. 1.

FIG. 3 illustrates a configuration of an adjustable pipe connector as shown in FIG. 1 for connecting two aligned pipes.

FIG. 4 illustrates a configuration of an adjustable pipe connector as shown in FIG. 1 for connecting two pipes whose axes are laterally displaced with respect to one another.

FIG. 5 illustrates a configuration of an adjustable pipe connector as shown in FIG. 1 for connecting two pipes whose axes are angularly misaligned with respect to one another.

FIG. 6 illustrates a configuration of an adjustable pipe connector as shown in FIG. 1 for connecting two pipes whose axes are both angularly misaligned and laterally displaced.

FIG. 7 shows a section through an adjustable pipe connector assembly, in accordance with an embodiment of the present invention.

FIG. 8 is a diagram of a variant of the adjustable pipe connector assembly shown in FIG. 7.

FIG. 9 shows a variant of the adjustable pipe connector assembly shown in FIG. 8.

FIG. 10 shows an adjustable pipe connector with a sleeve clamping enclosure in accordance with an embodiment of the present invention.

FIG. 11 shows an adjustable pipe connector assembly with a flange, in accordance with an embodiment of the present invention.

FIG. 12 shows components of the adjustable pipe connector assembly shown in FIG. 11.

FIG. 13 shows a section of a clamp for holding together an adjustable pipe connector assembly, in accordance with an embodiment of the present invention, with the clamp open.

FIG. 14 shows the adjustable pipe connector assembly with a clamp as shown in FIG. 13, with the clamp closed.

FIG. 15A shows components of a flat disk of an adjustable pipe connector in accordance with an embodiment of the present invention.

FIG. 15B shows a flat disk hat is assembled from the components shown in FIG. 15A.

FIG. 16 shows an adjustable pipe connector, in accordance with an embodiment of the present invention, incorporated into a vessel.

FIG. 17 shows a pair of adjustable pipe connectors, in accordance with an embodiment of the present invention, applied to connecting two manifolds.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

In accordance with embodiments of the current invention, an adjustable pipe connector includes at least three annular disks placed adjacently to one another. The two outer opposite external disks bracket a central disk. Each annular disk includes a centered or eccentrically situated hole or bore to enable the flow of fluid through the disk from one opposite surface of the disk to the other. Each of he disks may itself include a plurality of component disks, or additional disks may be added between the disks or adjacent to the disks. The disks are arranged such that their central bores at least partially overlap. Thus, a flow path is created whereby the unimpeded flow of fluid is enabled from one of the outer disks to the other. An end of each of two pipes may be attached to the bore of each of the outer disks so as to enable flow from one of the pipes to the other via the disks. For example, one or both of the outer disks may incorporate a pipe extension that extends outward from the bore.

The pipe extension may extend outward such that the distal end of the pipe extension reaches a pipe that is to be connected to the adjustable pipe connector. For example, a depth to which a proximal end of the pipe extension is screwed into a bore of a disk may be adjusted in order to achieve a desired length of the pipe extension. Alternatively, the pipe extension may be selected in accordance with a desired length. In some cases (e.g. when the distal end of the pipe extension does not include structure for use in connecting to the pipe), the pipe extension may be cut or sawed to a desired length. Alternatively, distance between distal ends of the pipe extensions may be adjusted by selection of the thickness of one or more of the disks of adjustable pipe connector.

The distal end of the pipe extension may be clamped, welded, threaded, bolted (e.g. via a flange), or otherwise connected to an end of a pipe that is to be connected via the adjustable pipe connector. As used herein, a “pipe” refers to any enclosure, tube, or duct for holding or conducting a fluid (e.g. liquid or gas). The pipe may be made of any material suitable for conducting or holding the fluid (e.g. metal, plastic, rubber, glass, or ceramic) and may have any suitably shaped cross section (e.g. circular, oval, polygonal, or any other symmetric or asymmetric closed shape). Alignment of each pipe may be defined by a location and orientation of a longitudinal central axis of the pipe. For example, the central axis may represent an axis of full or partial symmetry of the pipe (e.g. when the pipe cross section is characterized by a rotational symmetry, as with a cross section in the form of a circle, ellipse, rectangle, or regular polygon), or another characteristic axis (e.g. along a centroid of the cross section).

Typically, the faces of one of the outer disks (herein referred to as the flat disk) are parallel to one another and perpendicular to the axis of the bore through that outer disk. A face (herein referred to as the flat face) of the central disk that is designed to abut an inward-facing face of the flat disk is also perpendicular to the axis of the bore of the central disk. The other face (herein referred to as the inclined face) of the central disk is typically inclined with respect to the flat face. The inclination may be characterized by an inclination angle α, where a zero value of a would indicate that the two faces of the central disk are parallel to one another. The outward-facing face of the other outer disk (herein referred to as the inclined disk) is also perpendicular to the axis of the bore through the inclined disk. The inward-facing face of the inclined disk is typically inclined with an inclination that is similar to that of the inclined face of the central disk (e.g. with same inclination angle α relative to the outward-facing face of the inclined disk).

The outward-facing faces of the flat disk and of the inclined disk may each be connected to a pipe. For example, the outward-facing faces of the flat disk or of the inclined disk may include a pipe extension that is attached to (e.g. welded to) the bore of that disk, or that is integral with (e.g. cast together with) that disk. A separate pipe extension may be attached to the bore of the disk in order to adapt the adjustable pipe connector to a distance between the pipes to be connected. For example, an end of the pipe connector that is to be attached to the disk may be provided with external threading. The bore of the disk may be provided with internal threading. Thus, a pipe extension of suitable length may be selected and threaded into the bore of the disk.

The flat disk, the central disk, and the inclined disk are clamped or otherwise connected together or confined together (all such connecting or confining being herein referred to as clamping) by a suitable enclosure, flange, or clamp, to form an adjustable pipe connector. A configuration of the disks may be fixed by a fixing mechanism (may be identical to the enclosing mechanism). Formation or use of the pipe connector may enable connection of an end of a pipe that is connected to the flat disk to an end of a pipe that is connected to the inclined disk. Thicknesses of one or more of the flat disk, the central disk, and the inclined disk (typically of the central disk) may be selected to accommodate the pipe connector to a distance between the two pipe ends.

Effective clamping or fixing may require that a distance between the outward-facing faces of the pipe connector be approximately equal to a fixed distance (e.g. approximately equal to a width of a clamping structure or of an enclosure), and that the outward-facing faces be approximately parallel to one another. When necessary, additional rings or shims of appropriate thickness and with appropriately inclined faces may be added to the pipe connector (e.g. adjacent to the outward-facing surface of the flat disk or of the inclined disk) to form an adjustable pipe connector assembly suitable for clamping.

Prior to clamping the adjustable pipe connector assembly together, adjacent disks of the pipe connector may be rotated relative to one another. Relative rotation of adjacent disks of the pipe connector may enable the resulting pipe connector to connect misaligned pipes.

As a result of adjusting the adjustable pipe connector, the adjustable pipe connector may matchingly connect two ends of pipes. As used herein, two pipes are connected matchingly when the connecting ends of the pipe connector are well aligned with the pipes to be connected, and when stresses on or straining of the pipe connector is minimized.

For example, the bore of the flat disk may be situated eccentrically relative to an axis of symmetry of the perimeter of the flat disk. Such eccentric situation may enable the pipe connector to connect two pipes whose axes are laterally displaced relative to one another. In this case, rotation of the flat disk relative to the remainder of the pipe connector may enable adjustment of the direction of the displacement (e.g. when an inclination of the pipe connector as described below introduces an asymmetry in the pipe connector).

As another example, the inclined disk may be rotated relative to the central disk. As the inclined inward-facing face of the inclined disk rotates relative to the adjacent inclined face of the central disk, the relative orientation (bending angle) of the bore of the inclined disk relative to the bore of the remainder of the pipe connector changes. Thus, relative rotation between the inclined disk and the central disk may enable the pipe connector to connect two pipes whose axes are inclined relative to one another.

One or more of various configurations of flat disks, central disks, inclined disks, additional disks or shims, and clamping components may be included in a kit for constructing one or more pipe connectors, in accordance with embodiments of the present invention.

Reference is made to the accompanying figures.

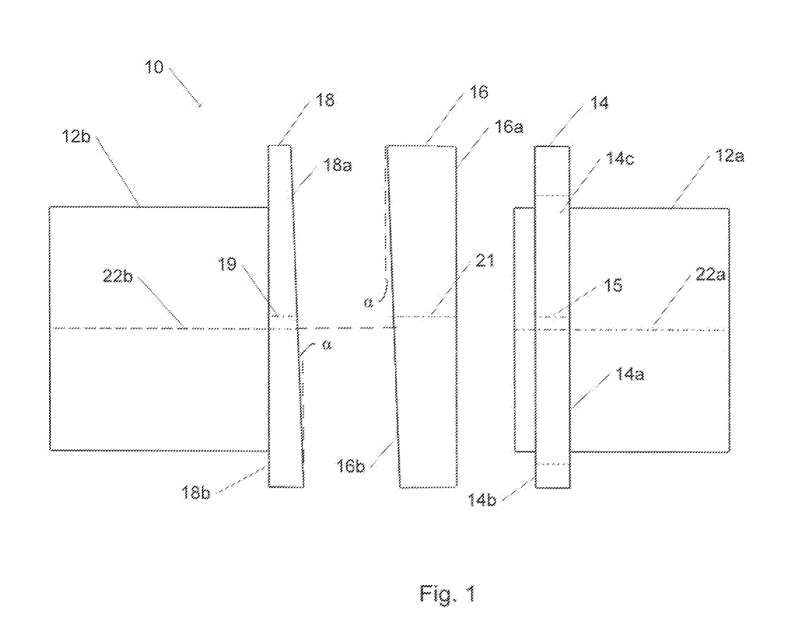

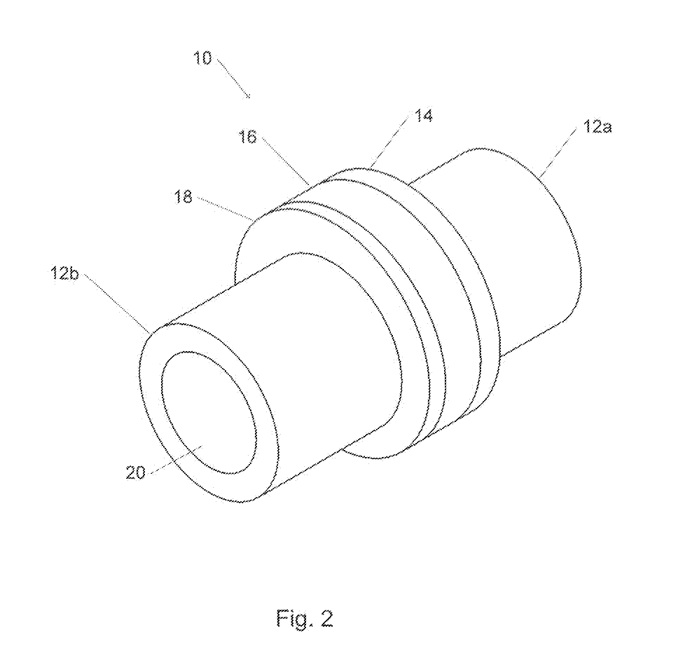

FIG. 1 illustrates components of an adjustable pipe connector in accordance with an embodiment of the present invention. FIG. 2 shows an adjustable pipe connector assembled from the components illustrated in FIG. 1.

Adjustable pipe connector 10 enables connection of two pipes such that a fluid may flow from one connected pipe to the other via bore 20 of adjustable pipe connector 10. For example, one of the pipes to be connected may be attached to pipe extension 12a, and the other to pipe extension 12b. Adjustable pipe connector 10 includes flat disk 14, central disk 16, and inclined disk 18 (and pipe extensions 12a and 12b).

In accordance with some embodiments of the present invention, a proximal end of pipe extension 12a or 12b may be connected to (e.g. screwed into) flat disk 14 or inclined disk 18, respectively. In other embodiments of the present invention, pipe extension 12a or 12b may be integral to (e.g. welded or cast together with) flat disk 14 or inclined disk 18, respectively. A distal end of pipe extension 12a or 12b may include structure (e.g. threading or a flange) to facilitate connection to a pipe.

For example, pipe extension 12a may be provided with outer threading and a bore 14c of flat disk 14 may be tapped so as to include inner threading. Thus, a proximal end of pipe extension 12a may be screwed into bore 14c of flat disk 14 so as to attach pipe extension 12a to flat disk 14. An extent to which pipe extension 12a is screwed into bore 14c of flat disk 14 may determine the distance that a distal end of pipe extension 12a extends outward from outward-facing face 14a of flat disk 14. Adjustment of the extension distance may enable adapting adjustable pipe connector 10 to a distance between the pipes that are to be connected.

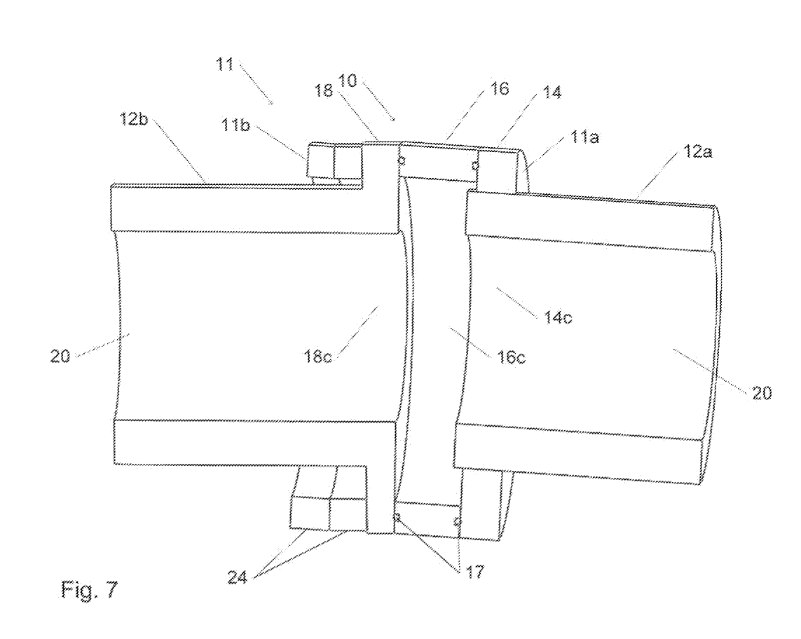

Outward-facing face 14a of flat disk 14 is parallel to inward-facing face 14b. A bore 20 (visible in FIG. 7) of pipe extension 12a is contiguous with bore 14c of flat disk 14. Pipe extension 12a (and bore 14c of flat disk 14) is mounted eccentrically on flat disk 14, such that bore axis 22a (coinciding with the axis of pipe extension 12a) is laterally displaced from flat disk axis 15 (which is substantially equidistant from all points on the outer perimeter of flat disk 14).

Flat face 16a of central disk 16 is parallel to inward-facing face 14a (and to outward-facing face 14b) of flat disk 14. Inclined face 16b is inclined by inclination angle α with respect to flat face 16a. Central disk 16 may be rotatable about central disk axis 21 (which is substantially equidistant from all points on the outer perimeter of central disk 16).

Inward-facing face 18a of inclined disk 18 is inclined by inclination angle α relative to outward-facing face 18b. A bore 20 of pipe extension 12b is contiguous with bore 18c (visible in FIG. 7) of inclined disk 18. Pipe extension 12b (and bore 18c of inclined disk 18) is mounted eccentrically on inclined disk 18, such that bore axis 22b (coinciding with the axis of pipe extension 12b) is laterally displaced from inclined disk axis 19 (which is substantially equidistant from all points on the outer perimeter of inclined disk 18).

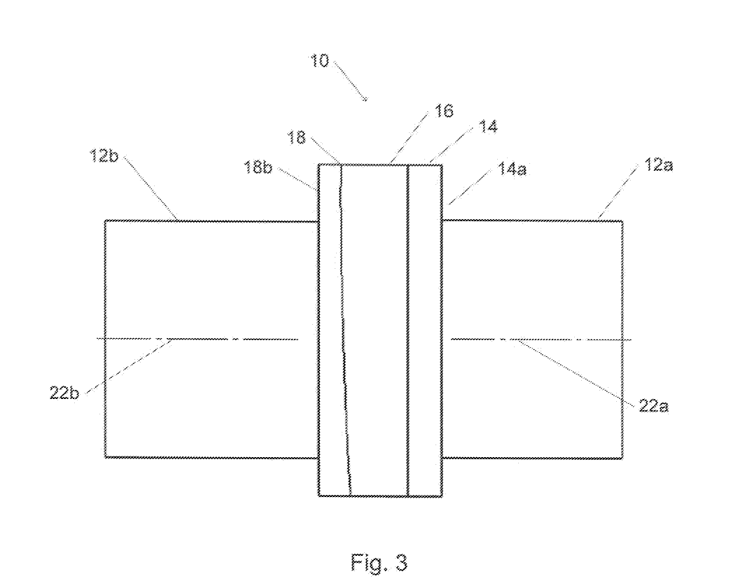

FIG. 3 illustrates a configuration of an adjustable pipe connector as shown in FIG. 1 for connecting two aligned pipes. For example, one of the aligned pipe ends to be connected may be attached to pipe extension 12a, and the other to pipe extension 12b. As shown in FIG. 3 (which also corresponds to the relative arrangement of flat disk 14, central disk 16, and inclined disk 18 in FIG. 1 and in FIG. 2), bore axis 22a of flat disk 14 is collinear with bore axis 22b of inclined disk 18. In the arrangement shown, inclined face 16b of central disk 16 cooperates with the inclined inward-facing face 18a of inclined disk 18 to cause outward-facing face 14a of flat disk 14 to be parallel to outward-facing face 18b of inclined disk 18.

Rotation of flat disk 14 with respect to central disk 16 may adjust adjustable pipe connector 10 so as to connect two pipes whose axes are laterally displaced relative to one another.

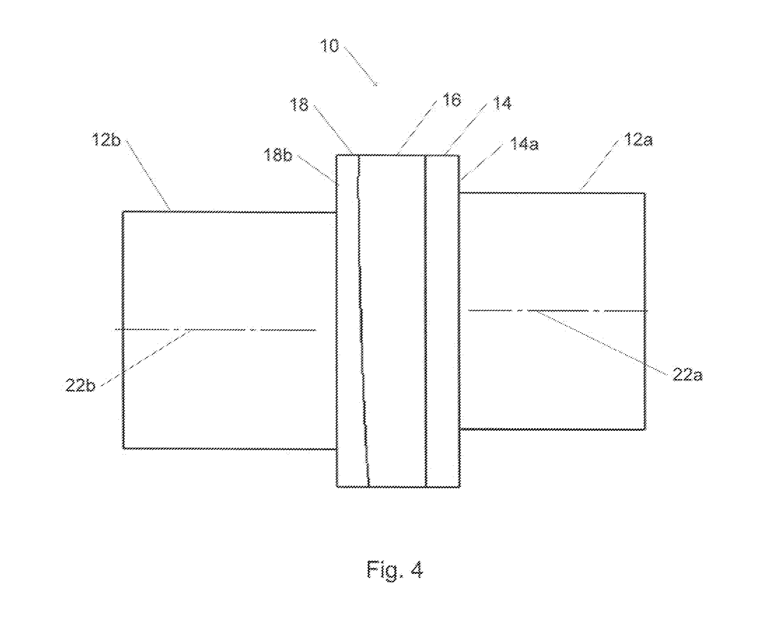

FIG. 4 illustrates a configuration of an adjustable pipe connector as shown in FIG. 1 for connecting two pipes whose axes are laterally displaced with respect to one another. For example, one of the laterally displaced pipe ends to be connected may be attached to pipe extension 12a, and the other to pipe extension 12b. As shown in FIG. 4, flat disk 14 has been rotated with respect to central disk 16 (e.g. from the configuration shown in FIG. 3) such that bore axis 22a of flat disk 14 (and of pipe extension 12a) is laterally displaced with respect to bore axis 22b of inclined disk 18 (and of pipe extension 12b). The rotation of flat disk 14 relative to central disk 16 does not change the orientation of bore axis 22a. Therefore, after the rotation bore axis 22a remains parallel to bore axis 22b and outward-facing face 14a of flat disk 14 remains parallel to outward-facing face 18b of inclined disk 18.

Rotation of inclined disk 18 with respect to central disk 16 may adjust adjustable pipe connector 10 so as to connect two pipes whose axes are angularly misaligned relative to one another.

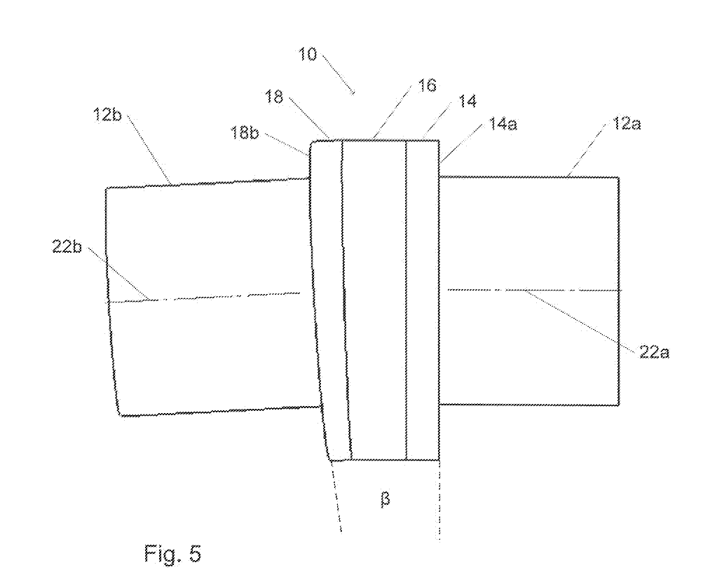

FIG. 5 illustrates a configuration of an adjustable pipe connector as shown in FIG. 1 for connecting two pipes whose axes are angularly misaligned with respect to one another. For example, one of the angularly misaligned pipe ends to be connected may be attached to pipe extension 12a, and the other to pipe extension 12b. As shown in FIG. 5, inclined disk 18 has been rotated relative to central disk 16 (as shown in FIG. 4). As a result of the rotation, outward-facing face 18b of inclined disk 18 is inclined with an angle β relative to outward-facing face 14a of flat disk 14. Bore axis 22b of inclined disk 18 is similarly inclined by angle β relative to bore axis 22a of flat disk 14. Rotation of inclined disk 18 relative to central disk 16 may cause angle β to vary from zero (where bore axis 22b is parallel to bore axis 22a, as in FIG. 3 or in FIG. 4) to a maximum value equal to twice inclination angle α (FIG. 1). As shown in FIG. 5, flat disk 14 has been rotated relative to central disk 16 so as to minimize or eliminate any lateral displacement of bore axis 22b from bore axis 22a.

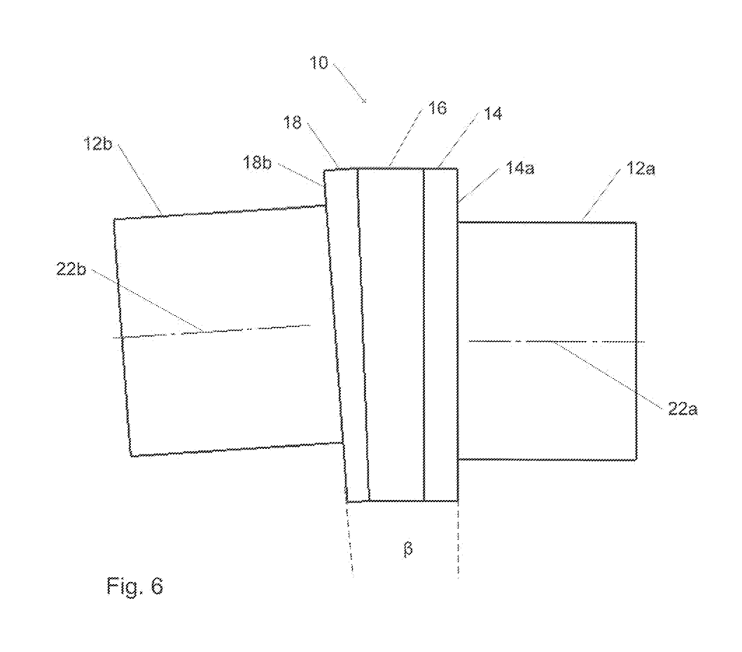

FIG. 6 illustrates a configuration of an adjustable pipe connector as shown in FIG. 1 for connecting two pipes whose axes are both angularly misaligned and laterally displaced. For example, one of the angularly misaligned and laterally displaced pipe ends to be connected may be attached to pipe extension 12a, and the other to pipe extension 12b. Flat disk 14 has been rotated with respect to central disk 16 so as to adjust the lateral displacement of bore axis 22a with respect to bore axis 22b. Similarly, inclined disk 18 has been rotated with respect to central disk 16 so as to adjust the angular misalignment of bore axis 22b with respect to bore axis 22a.

Components of an adjustable pipe connector may be assembled together. An adjustable pipe connector assembly may include one or more additional components. Such components may include, for example, various washers or spacers, as well as sealing rings. Components of the adjustable pipe connector assembly may be held together by a suitable mechanism, such as, for example, a clamp, bracket, or enclosure. Components of the adjustable pipe connector assembly may be held together by welding, gluing or other adhesion, bolting, tying, or belting.

A mechanism for holding together components of adjustable pipe connector assembly may require that outward-facing faces of the adjustable pipe connector assembly be parallel to one another or be separated by a fixed distance. As described above, a configuration of flat disk 14, central disk 16, and inclined disk 18 may be adapted to a particular alignment between the pipes that are to be connected. Therefore, a distance or relative inclination between outward-facing face 14a of flat disk 14 and outward-facing face 18b of inclined disk 18 may not conform to the requirements of the clamping or enclosing mechanism.

In accordance with some embodiments of the current invention, one or more additional fittings may be placed around pipe extension 12a or 12b, for example adjacent to outward-facing face 14a of flat disk 14 or outward-facing face 18b of inclined disk 18. The additional fittings may be included among components of an adjustable pipe connector assembly, together with components of adjustable pipe connector 10.

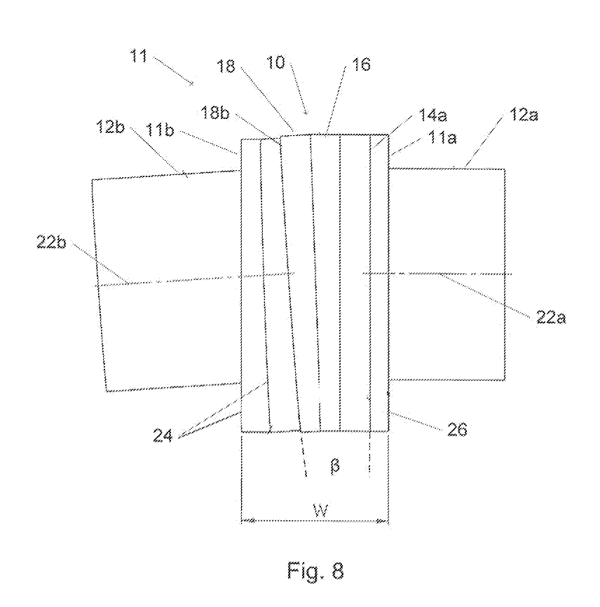

FIG. 7 shows a section through an adjustable pipe connector assembly, in accordance with an embodiment of the present invention. FIG. 8 is a diagram of a variant of the adjustable pipe connector assembly shown in FIG. 7.

Adjustable pipe connector 10 within adjustable pipe connector assembly 11, as shown in FIG. 7 and in FIG. 8, is configured to accommodate angular misalignment between two pipes. As a result, outward-facing face 18b of inclined disk 18 is inclined with respect to outward-facing face 14a of flat disk 14 by angle β. A mechanism for holding together components of adjustable pipe connector assembly 11 may be configured to operate on parallel outward-facing surfaces. In order to compensate for the inclination of outward-facing face 18b with respect to outward-facing face 14a by angle β, adjustable pipe connector assembly 11 may include one or more inclined rings 24. Inclined rings 24 may be placed adjacent to outward-facing face 18b or outward-facing face 14a. As shown in FIG. 7 and in FIG. 8, two inclined rings 24 have been placed around pipe extension 12b and adjacent to outward-facing face 18b. As a result, outer surface 11b of adjustable pipe connector assembly 11 is parallel to outward-facing surface 14a (and to outer surface 11a of adjustable pipe connector assembly 11).

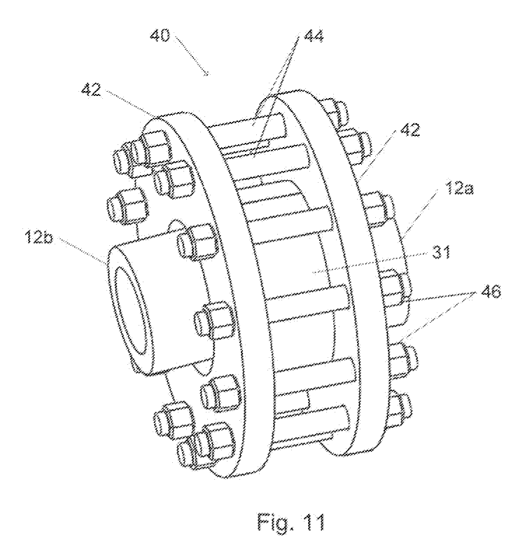

A mechanism for holding together components of adjustable pipe connector assembly 11 may be configured to operate on outward-facing surfaces with a particular separation W. In order that the width of adjustable pipe connector assembly 11 be equal to width W, adjustable pipe connector assembly 11 may include a shim assembly 26, shown (in FIG. 8) as placed around pipe extension 12a and adjacent to flat disk 14. Shim assembly 26 may include one or more flat shim rings 28 (visible in FIG. 11). The thickness of shim assembly 26 (e.g. adjustable by selection of a quantity or thickness of flat shim rings 28 that are to be included in shim assembly 26) may be adjusted to compensate for a difference between width W and a total width (or thickness) of the other components of adjustable pipe connector assembly 11 (e.g. adjustable pipe connector 10 and inclined rings 24). As a result of addition of shim assembly 26, the distance between outer surface 11a and outer surface 11b of adjustable pipe connector assembly 11 may be made equal to a desired width W. Outer surface 11a of adjustable pipe connector assembly 11 is parallel to outer surface 11b of adjustable pipe connector assembly 11.

As shown (FIG. 7), a space between flat disk 14 and central disk 16, as well as the similar space between central disk 16 and inclined disk 18, may be sealed by a sealing ring or device, such as O-ring 17. O-ring 17 may thus prevent or inhibit leakage of fluid from adjustable pipe connector 10.

As shown (FIG. 7), bore 16c of central disk 16 is larger than either bore 14c of flat disk 14 or bore 18c of inclined disk 18. Thus, any rotation of either flat disk 14 or inclined disk 18 relative to central disk 16 would not obstruct any of bores 14c, 16c, or 18c. Although bore 14c of flat disk 14 is shown as being equal in diameter to bore 18c of inclined disk 18, bores 14c and 18c may have different diameters.

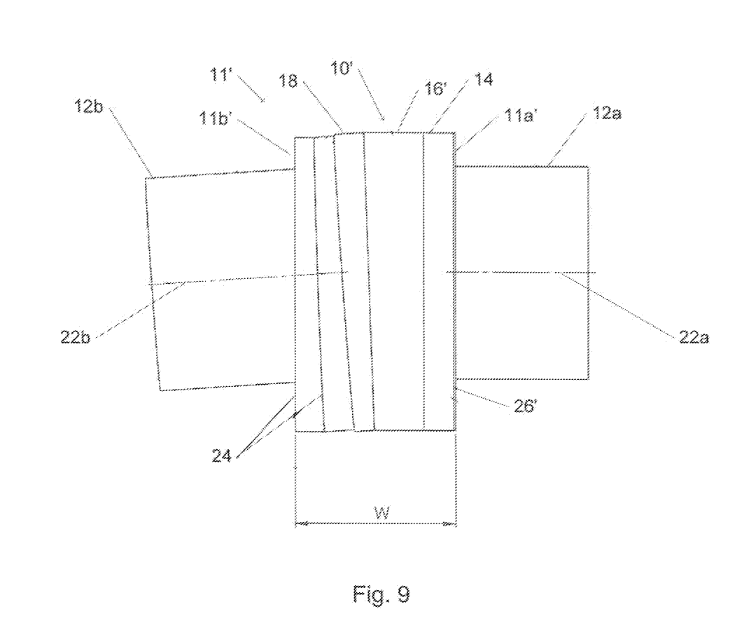

The configuration of adjustable pipe connector assembly 11 may vary as needed, e.g. in accordance with a configuration of adjustable pipe connector 10. FIG. 9 shows a variant of the adjustable pipe connector assembly shown in FIG. 8.

In alternative adjustable pipe connector assembly 11′, wide central disk 16′ of alternative adjustable pipe connector 10′ has a different (larger) thickness than central disk 16 of adjustable pipe connector 10 (shown in FIG. 8). For example, wide central disk 16′ may be used in place of central disk 16 in order to accommodate the separation between distal ends of pipe extensions 12a and 12b to a distance between two pipes that are to be connected. Since wide central disk 16′ of alternative adjustable pipe connector 10′ is wider than central disk 16 of adjustable pipe connector 10, the distance between outer surface 11a′ and outer surface 11b′ may be made equal to W through inclusion of narrow shim assembly 26′ (narrower than shim assembly 26) in alternative adjustable pipe connector assembly 11′.

Components of an adjustable pipe connector (or of an adjustable pipe connector assembly) may be held together by a suitable mechanism. For example, a mechanical clamping or enclosure mechanism may be utilized. As another example, components may be caused to adhere to one another by applying, for example, welding, gluing, epoxy, adhesive tape, shrink wrap, or adhesive tape. One or more sealant materials may be utilized where two components meet within an adjustable pipe connector or within an adjustable pipe connector assembly.

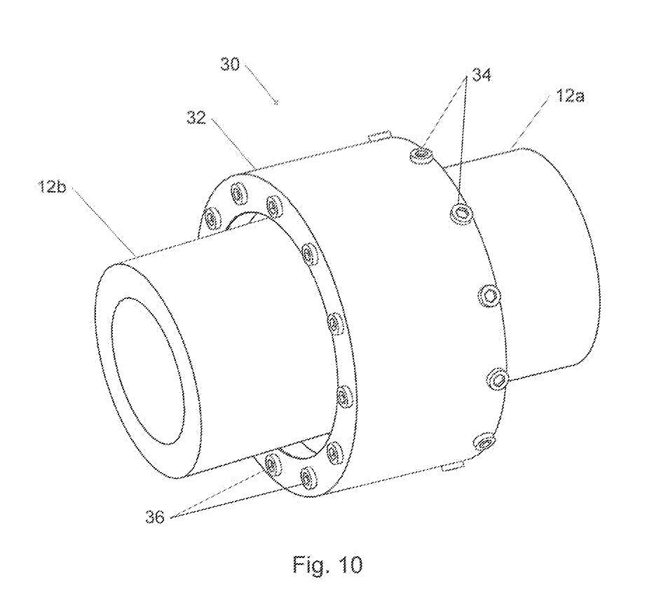

For example, a mechanical clamping enclosure, in accordance with some embodiments of the present invention, may include a mechanical sleeve. FIG. 10 shows an adjustable pipe connector assembly with a sleeve clamping enclosure in accordance with an embodiment of the present invention.

Adjustable pipe connector assembly 30 includes sleeve 32. Sleeve 32 may be configured (e.g. its inner surface appropriately shaped) so as to hold components of an adjustable pipe connector assembly together. For example, radial set screws 34 and axial set screws 36 may be appropriately tightened so as to fix a configuration of an enclosed adjustable pipe connector.

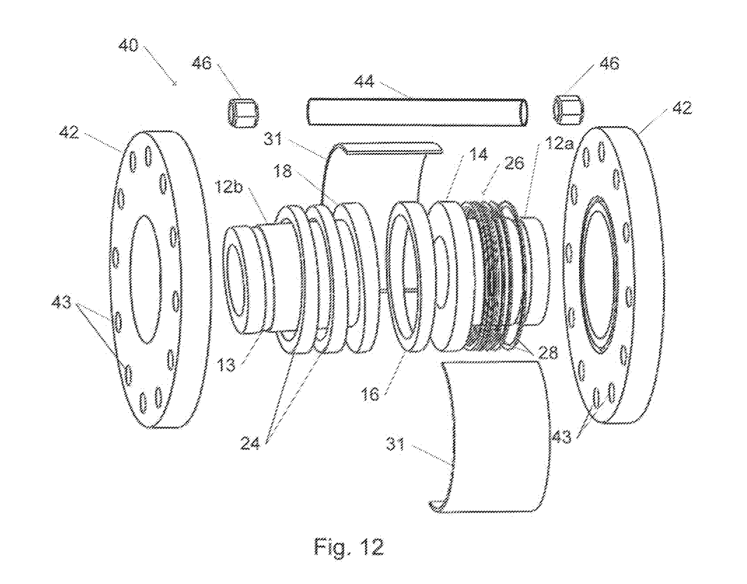

In accordance with some other embodiments of the present invention, a clamping enclosure may include a flange. FIG. 11 shows an adjustable pipe connector assembly with a flange, in accordance with an embodiment of the present invention. FIG. 12 shows components of the adjustable pipe connector assembly shown in FIG. 11.

Components of flanged adjustable pipe connector assembly 40, such as flat shim rings 28, flat disk 14, central disk 16, inclined disk 18, and inclined rings 24, are all held between flanges 42 and surrounded by encasing sleeve 31. Stud bolts 44 are configured to fit through holes 43 in each of flanges 42. Nuts 46 may be tightened on threading at the ends of stud bolts 44 in order to attach flanges 42 to one another. Further tightening of nuts 46 may apply inward force so as to force flanges 42 toward one another. The inward force on flanges 42 squeezes the components of bolted adjustable pipe connector assembly 40, thereby connecting pipe segment 12a to pipe segment 12b.

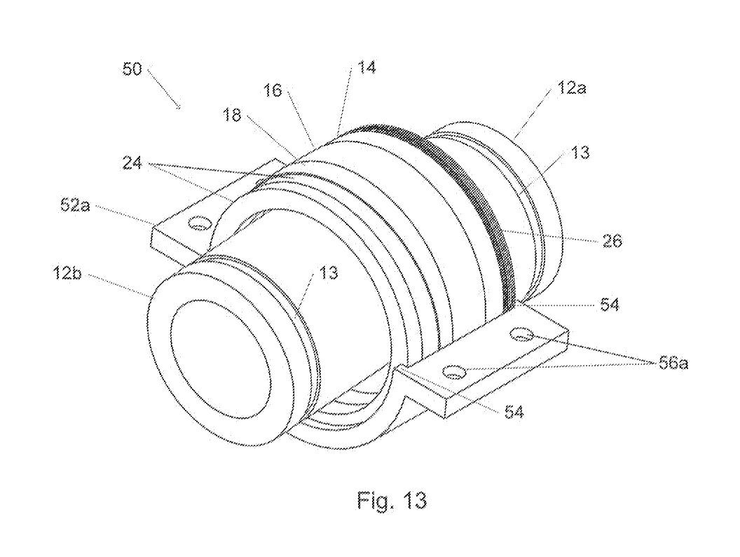

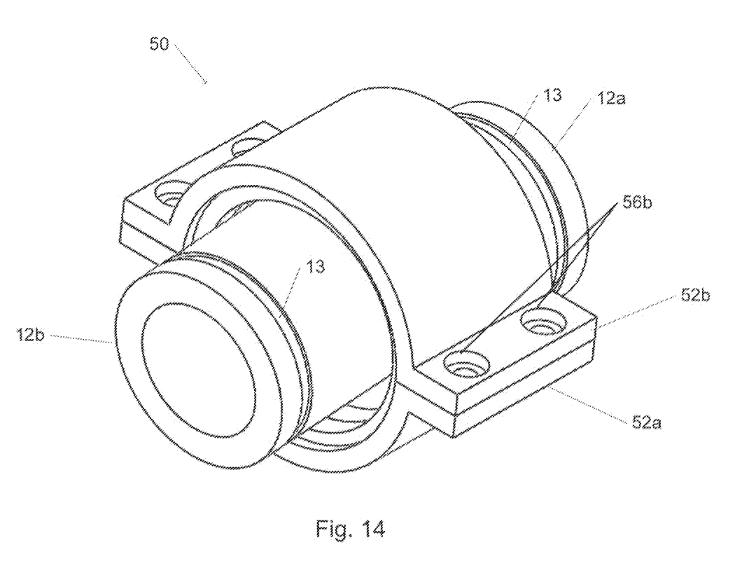

In accordance with some other embodiments of the present invention, an adjustable pipe connector assembly may be held together by a clamp. FIG. 13 shows a section of a clamp for holding together an adjustable pipe connector assembly, in accordance with an embodiment of the present invention, with the clamp open. FIG. 14 shows the adjustable pipe connector assembly with a clamp as shown in FIG. 13, with the clamp closed.

Components of clamped adjustable pipe connector assembly 50, such as flat shim rings 28, flat disk 14, central disk 16, inclined disk 18, and inclined rings 24, may be held together by clamp section 52a cooperating with clamp section 52b. Protruding lips 54 of clamp section 52a (and similar protruding lips of clamp section 52b—which are not shown) may be spaced (e.g. an axial distance between them being equal to width W) so as to hold the aforementioned components of clamped adjustable pipe connector assembly 50 tightly together.

Bolt holes 56a of clamp section 52a may be aligned with bolt holes 56b of clamp section 52b. A bolt may then be inserted through an aligned pair of bolt holes 56b and 56a and tightened (e.g. into threading in a bolt hole 56a) so as to hold clamp section 52a and clamp section 52b together. Another method may be applied to attach clamp section 52a to clamp section 52b. Holding clamp section 52a and clamp section 52b together may thus hold clamped adjustable pipe connector assembly 50 together.

As shown in FIGS. 13 and 14, pipe extension 12a and pipe extension 12b are each provided with a circumferential groove 13 (labeled only on pipe extension 12b). Circumferential groove 13 may accommodate a sealing ring or connecting structure for connecting pipe extension 12a or pipe extension 12b to a pipe.

In accordance with some embodiments of the present invention, a disk of an adjustable pipe connector may be assembled out from a plurality of components. For example, components of a disk may be rotatable relative to one another. Such relatively rotatable components may enable finer adjustment of a lateral displacement (e.g. in the case of a flat disk) or an angular inclination (e.g. in the case of an inclined disk) than may be achievable otherwise. Components of the disk may include a pipe extension that may be attached to the disk.

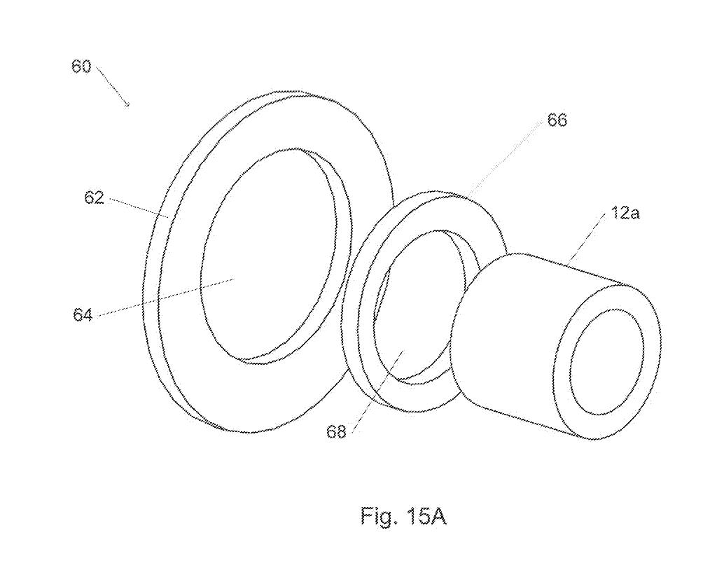

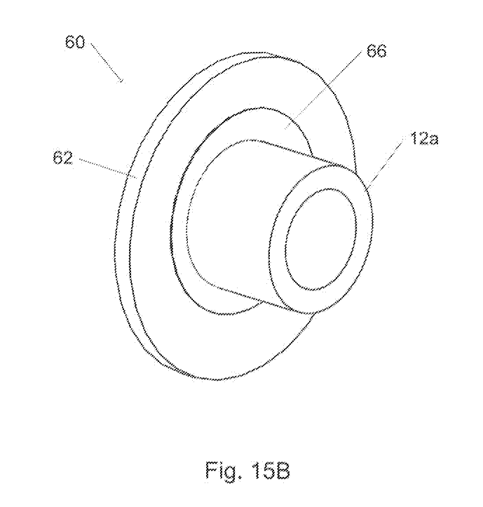

FIG. 15A shows components of a flat disk of an adjustable pipe connector in accordance with an embodiment of the present invention. FIG. 15B shows a flat disk hat is assembled from the components shown in FIG. 15A.

Flat disk 60 includes outer ring 62. Outer ring 62 includes an eccentrically located bore 64. Inner ring 66 may be assembled out into bore 64 in such a manner that when assembled, inner ring 66 is rotatable within bore 64. For example, suitable structure may be provided to hold inner ring 66 within bore 64 in such a manner as to enable rotation of inner ring 66 relative to bore 64 and outer ring 62.

Inner ring 66 includes an eccentrically located bore 68. Pipe extension 12a may be attached within bore 68. For example, bore 68 may be provided with internal threading while pipe extension 12a is provided with exterior threading. Pipe extension 12a may thus be screwed into bore 68. The amount by which pipe extension 12a is screwed into bore 68 may determine a length of pipe extension 12a exterior to flat disk 60.

In order to configure flat disk 60 for a desired lateral displacement of pipe extension 12a from a central axis of flat disk 60, both outer ring 62 and inner ring 66 may be rotated (each about the central axis of that ring). For example, outer ring 62 may be rotated relative to other disks of an adjustable pipe connector. Inner ring 66 may be rotated relative to outer disk 62. The combination of rotations may enable finer adjustment of a total lateral displacement than may be possible with a single rotating component.

Although in the example shown in FIGS. 15A and 15B, the flat disk is assembled from two nested rings, configurations that are assembled from three or more nested rings are possible. For example, with a plurality of rings, each ring except for the outermost is configured to be assembled to rotate within a bore of a surrounding ring.

Similarly, an inclined disk or a central disk may be assembled from a plurality of component rings. For example, each component ring may be inclined by a fraction of angle α (FIG. 1). An inclined disk may be configured (e.g. with a tapped bore) to enable attachment of a pipe extension (e.g. with external threading).

An adjustable pipe connector in accordance with embodiments of the present invention may be utilized to connect pipes, e.g. in situations where adjustability is important.

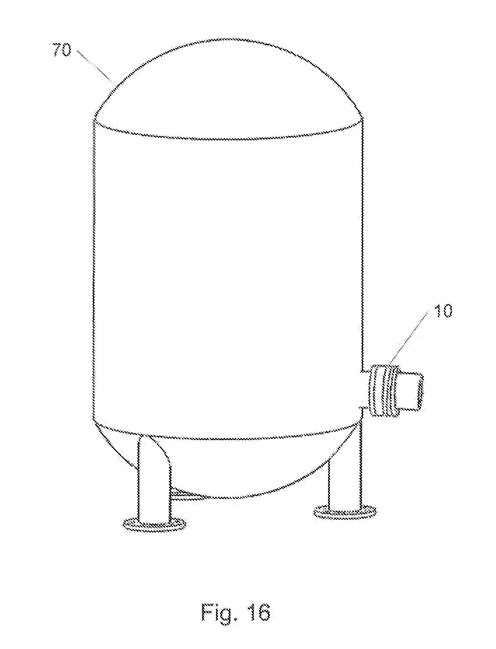

FIG. 16 shows an adjustable pipe connector, in accordance with an embodiment of the present invention, as incorporated into a vessel. Vessel 70 may be installed at a location and may be required to connect to an existing pipe or networks of pipes. If vessel 70 is difficult to move (e.g. is very heavy), than fine adjustment of the position of vessel 70 relative to existing piping may not be practical or possible. Thus, vessel 70 may be provided with adjustable pipe connector 10. For example, adjustable pipe connector 10 may be incorporated as a component of vessel 70 as part of manufacture of vessel 70. Although adjustable pipe connector 10 is shown in FIG. 16 without any containment or clamping structure, such structure may be included.

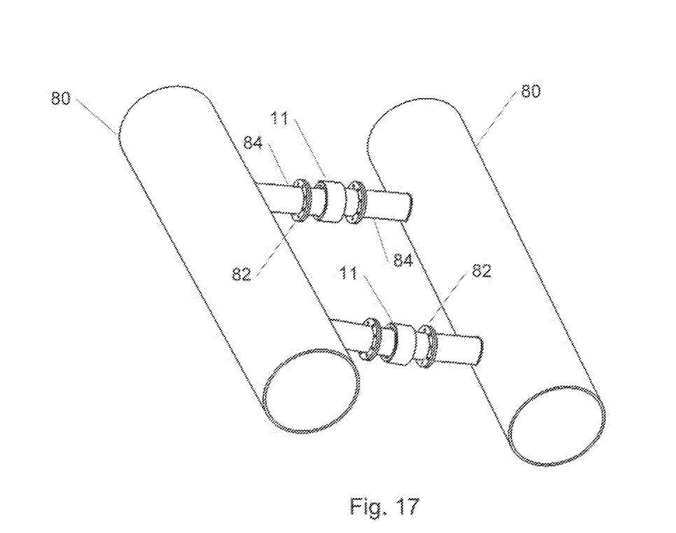

FIG. 17 shows a pair of adjustable pipe connectors, in accordance with an embodiment of the present invention, applied to connecting two manifolds. Each manifold 80 may be assembled into a structure in such a manner that movement of an installed manifold 80 may not be practical or possible. Thus when connecting two manifolds 80 together via connector pipes 84, an adjustable pipe connector assembly 11 may utilized to compensate for any misalignment between one connector pipe 84 and another. In the example shown, ends of adjustable pipe connector assembly 11 are provided with flanges 82. Flanges 82 may connect to a similar flange 82 on an end of a connector pipe 82.

In accordance with embodiments of the present invention, a method may be applied to adjustably connect pipes together. In describing the method, reference is made to items shown in FIGS. 1 through 16. It should be understood that the order of actions or operations of the method as described below has been selected for convenience only. Operations may be executed in different order or concurrently with equivalent results, or operations may be repeated as needed. All such rearrangement of the described operations should be understood as being included within embodiments of the present invention.

For example, an adjustable pipe connector may be configured to connect two pipes. A flat disk 14 may be connected to one of the pipes (e.g. via a pipe extension 12a that is connected to flat disk 14), and an inclined disk 18 to the other (e.g. via a pipe extension 12b that is connected to inclined disk 18). A central disk 16 is placed between flat disk 14 and inclined disk 18. A sealing ring, such as O-ring 17 (FIG. 7) may be placed between flat disk 14 and central disk 16, between central ring 16 and inclined disk 18, or both.

One or more of flat disk 14, central disk 16, and inclined disk 18 may be assembled prior to connection to a pipe or to inclusion in an adjustable pipe connector 10.

In particular, a pipe extension 12a may be attached to a flat disk 14, or a pipe extension 12b may be attached to an inclined disk 18. The attachment may be such (e.g. by selecting a length screwed into the disk) as to achieve a desired length of pipe extension 12a or 12b. The length may be selected so as to accommodate a distance between the pipes that are to be connected.

As another example of accommodation of a distance between pipes, a central disk 16 may be selected with a thickness (e.g. a thickness of central disk 16 in FIG. 8, of thick central disk 16′ in FIG. 9, or of another thickness) that enables connection of ends of pipes that are separated by a particular distance (e.g. the distance being determined by design constraints). As another example, a thickness of flat disk 14 or of inclined disk 18 may be selected so as to accommodate the separation.

Inclined disk 18 may be rotated relative to central disk 16 in order to adjust a relative angle between axes of pipe extension 12a and of pipe extension 12b (e.g. the relative angle being determined by design constraints). For example, one relative rotation may result in angularly aligned pipe extensions 12a and 12b (e.g. as shown in FIG. 3). Another relative rotation may result in angularly misaligned pipe extensions 12a and 12b (e.g. as shown in FIG. 5).

Flat disk 14 may be rotated relative to central disk 16 in order to adjust a lateral displacement between axes of pipe extension 12a and of pipe extension 12b (e.g. the lateral displacement being determined by design constraints). For example, one relative rotation may result in collinear (zero lateral displacement between) pipe extensions 12a and 12b (e.g. as shown in FIG. 3 for angularly aligned pipe extensions 12a and 12b, or in FIG. 5 for angularly misaligned pipe extensions 12a and 12b). Another relative rotation may result in a nonzero lateral displacement between axes of pipe extensions 12a and 12b (e.g. as shown in FIG. 4 for angularly aligned pipe extensions 12a and 12b, or in FIG. 6 for angularly misaligned pipe extensions 12a and 12b). Combined rotations of an outer ring 62 and of an inner ring 66 of a flat disk 60 may enable fine adjustment of a lateral displacement.

If the outward-facing faces of flat disk 14 and of inclined disk 18 are not parallel, one or more additional inclined rings 24 may be placed adjacent to one or both of the outward-facing faces (e.g. adjacent to outward-facing face 18b of inclined disk 18, as shown in FIGS. 7-9), to form part of an adjustable pipe connector assembly 11. One or more of inclined rings 24 may be rotated so as to provide an outer face that is parallel to outward-facing face 14a.

If the distance between outer faces of an adjustable pipe connector assembly 11 are less than a predetermined distance (e.g. width W as shown in FIGS. 8 and 9, e.g. determined by a size of a clamping or enclosing structure), one or more shim assemblies (e g shim assembly 26 or alternative shim assembly 26′) may be placed within adjustable pipe connector assembly 11. For example, a shim assembly 26 that includes one or more shim rings 28 may be placed adjacent to outward-facing face 14a of flat disk 14 as shown in FIGS. 7-9 (or, e.g. adjacent to outer face 11b of adjustable pipe connector assembly 11 or outer face 11b′ of alternative adjustable pipe connector assembly 11′).

Components of a resulting adjustable pipe connector assembly 11 that includes adjustable pipe connector 10 may be attached to one another. Attaching to one another may fix a configuration of pipe extensions 12a and 12b.

For example, components of an adjustable pipe connector assembly 30 may be held together by a sleeve 30, as shown in FIG. 10. As another example, components of a bolted adjustable pipe connector assembly 40 may be held between flanges 42 and surrounded by encasing sleeve 31, as shown in FIGS. 11-12. As yet another example, components of a clamped adjustable pipe connector assembly 50 may be held together by a clamp 52, as shown in FIGS. 13-14. Other mechanisms or techniques may be utilized to hold components of a pipe connector assembly together.

Components of an adjustable pipe connector or an adjustable pipe connector assembly may be provided as a kit. For example, a kit may include (referring e.g. to FIG. 11) at least one or more of the following: flat disks 14, central disks 16, inclined disks 18, inclined rings 24, pipe extensions 12a or 12b, flat shim rings 28, O-rings 17 or other sealing rings, sleeves 31, flanges 42 or 82, stud bolts 44, nuts 46, inner rings 66, outer rings 62, clamp sections 52a, clamp sections 52b, bolts, connecting structure, or other disk components. Additional components, materials, or tools may be included. Various components may be provided with varied properties or characteristics. Such variable properties may include, for example, (e.g. depending on the individual component or on an intended use of the kit) outer diameter, bore diameter, thickness, inclination angle, eccentric placement of bore, material, color, connector type, length, or width. Various pipe extensions 12a or 12b may be provided with various connecting structures at their distal ends (e.g. flanges, threading, grooves for sealing rings, holes, or slots). By utilizing such a kit, an adjustable pipe connector may be configured to connect any of a wide variety of pipes.

1. An adjustable connector device for connecting two pipes, each of the pipes having a central axis, the device comprising:
at least three disks, each of the disks having a bore extending between opposite surfaces of that disk, said at least three disks including two opposite external disks and a central disk between the two opposite external disks, the bore of each of the opposite external disks being connectable to one of the pipes, each of the opposite external disks being rotatable relative to the central disk so as to achieve a configuration wherein the device matchingly connects between the pipes when the central axes of the pipes are laterally offset, angularly misaligned or both, the bores of said at least three disks forming a flow path between the pipes.

2. The device of claim 1, wherein one of the opposite external disks comprises a flat disk whose opposite surfaces are substantially parallel to one another, wherein the opposite surfaces of the central disk are inclined with respect to one another, and wherein the other of the opposite external disks comprises an inclined disk with its opposite surfaces being inclined with respect to one another.

3. The device of claim 2, wherein an inclination angle between the opposite surfaces of the central disk is substantially equal to an inclination angle between the opposite surfaces of the inclined disk.

4. The device of claim 1, wherein the bore of a disk of the opposite external disks is eccentrically positioned relative to that disk.

5. The device of claim 5, wherein said disk of the opposite external disks comprises a ring with an eccentrically positioned bore that is rotatable within an eccentrically positioned bore of a surrounding ring.

6. The device of claim 1, further comprising a mechanism for fixing the configuration, the mechanism being selected from a group of mechanisms consisting of a sleeve, a flange, and a clamp.

7. The device of claim 1, further comprising a sealing ring between a disk of the opposite external disks and the central disk.

8. The device of claim 1, comprising a pipe extension that extends from the bore of a disk of the opposite external disks.

9. The device of claim 8, wherein a distance of a distal end of the pipe extension from the disk from which the pipe extension extends is adjustable.

10. A method for connecting two pipes, the method comprising:
providing at least three disks, each of the disks having a bore extending between opposite surfaces of that disk, said at least three disks including two opposite external disks and a central disk between the opposite external disks, each of the opposite external disks being rotatable relative to the central disk, the bores of said at least three disks forming a flow path, one of the two opposite external disks including a flat disk and the other including an inclined disk, the opposite surfaces of the flat disk being substantially parallel to one another and the bore of the flat disk being eccentrically positioned relative to the opposite surfaces of the flat disk, the opposite surfaces of the central disk being inclined with respect to one another, the opposite surfaces of the inclined disk being inclined with respect to one another;
rotating the inclined disk relative to the central disk to accommodate an angular misalignment between the two pipes;
rotating the flat disk relative to the central disk to accommodate a lateral offset between the two pipes; and
attaching one of the two pipes to the bore of the flat disk and the other of the two pipes to the bore of the inclined disk.

11. The method of claim 10, further comprising selecting a thickness of a disk of said at least three disks so as to accommodate a distance between the two pipes.

12. The method of claim 11, fixing a configuration of said at least three disks by operation of a mechanism selected from a group of mechanisms consisting of a sleeve, a flange, and a clamp.

13. The method of claim 10, further comprising placing an inclined ring or a flat shim ring adjacent to an outward-facing surface of one of the opposite external disks so as to enable operation of a mechanism for fixing a configuration of said at least three disks.

14. The method of claim 10, further comprising attaching a pipe extension to the bore of a disk of the opposite external disks.

15. The method of claim 14, wherein attaching the pipe extension comprises adjusting a distance between a distal end of the pipe extension and said disk of the opposite external disks.

16. The method of claim 15, wherein adjusting the distance comprises adjusting an extent to which the pipe extension is screwed into the bore of said disk of the opposite external disks.

17. The method of claim 15, wherein attaching the pipe extension to the bore of said disk of the opposite external disks comprises attaching the pipe to a distal end of the pipe extension.

18. The method of claim 10, further comprising assembling a disk of said at least three disks from disk components.

19. The method of claim 10, wherein rotating the flat disk further comprises rotating an inner ring of the flat disk relative to an outer ring of the flat disk.

20. A kit for providing components of an adjustable pipe connector, the kit including at least a component selected from a group of components consisting of: a flat disk, a central disk, an inclined disk, a pipe extension, an inclined ring, a flat shim ring, an O-ring, a sleeve, a flange, a stud bolt, a nut, and a clamp section.
